(19) United States
(12) Patent Application Publication
(10) Pub. No.: US 2015/0254277 A1
(43) Pub. Date: Sep. 10, 2015

(54) SCHEMATIC REPRESENTATION OF GEOGRAPHIC LOCATIONS

(71) Applicant: GOOGLE INC., Mountain View, CA (US)

(72) Inventors: Taj J. Campbell, San Francisco, CA (US); Madoka Katayama, Tokyo (JP)

(21) Appl. No.: 14/636,980

(22) Filed: Mar. 3, 2015

Related U.S. Application Data
(60) Provisional application No. 61/947,842, filed on Mar. 4, 2014.

(51) Int. Cl. G06F 17/30; G06F 3/0484; G06F 3/0482

(52) U.S. Cl. CPC G06F 17/30241; G06F 3/0482; G06F 3/04842; G06F 3/04847

(57) ABSTRACT

A method for providing interactive geographic content via a user interface includes receiving a description of several geographic areas of different sizes and determining, for each of the geographic areas, travel time between the geographic area and a current location of a user. The method also includes displaying individually selectable indicators, each representing a respective one of the geographic areas. Displaying the indicators includes arranging the indicators relative to a point corresponding to the current location, at distances determined based on the corresponding travel times. In response to an indication that one of the indicators has been selected, the method includes displaying geographic information related to the corresponding geographic area.

### FIELD OF TECHNOLOGY

The present disclosure relates generally to conveying location information to users of client devices and, more particularly, to a schematic representation of neighboring geographic areas for display on client devices.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Due to small screen sizes, applications executed on mobile computing devices, such as smartphones, often display information to users of the mobile computing devices in a variety of formats. In certain cases, a mapping or navigation application may present information (e.g., about points of interest) to users in the form of an interactive digital map, while, in other cases, the mapping application may present information to users in the form of a list or table. A simultaneous display of both the digital map and list or table may not be practical due to a lack of available screen space, and, even if both formats were displayed simultaneously, the resulting display would likely become difficult to read and/or visually unattractive.

At the same time, it is often difficult for users to visualize or recognize geographic locations or a current geographic position or context while in a list or table view/format of a mapping application. For example, a search for “coffee” in a mapping application may return a list view of nearby coffee shops (e.g., within a certain radius of a current mobile device location or within a bounding box of a previously displayed map viewport). However, when the list view is displayed, a user will likely have difficulty in visualizing the geographic locations corresponding to the list items. Further, a user may wish to narrow listed results of a search to a specific geographic area (e.g., a specific neighborhood of a large city) or expand listed results beyond a current geographic area. Such geographically based interactions are not easily accomplished in a list view. Rather, a user will likely have to perform a series of inconvenient actions to input such geographically based interactions, including switching from the list view of the application to a map view of the application.

### SUMMARY

In one embodiment, a method for providing interactive geographic content via a user interface includes steps executed by one or more processors. The method includes receiving a description of several geographic areas of different sizes. The method also includes determining, for each of the geographic areas, travel time between the geographic area and a current location of a user, and displaying individually selectable indicators, each representing a respective one of the geographic areas. Displaying the indicators includes arranging the indicators relative to a point corresponding to the current location, at distances determined based on the corresponding travel times. In response to an indication that one of the indicators has been selected, the method includes displaying geographic information related to the corresponding geographic area.

Another embodiment of these techniques is a user device including a display device, a communication interface; and processing hardware coupled to the display device and the communication interface, the processing hardware. The processing hardware is configured to (i) receive a description of several geographic areas of different sizes for each of the geographic areas, (ii) determine a respective travel time between the geographic area and a reference location, (iii) display individually selectable indicators on the display device, each representing a respective one of the geographic areas, arranged relative to a point on the display device corresponding to the reference location, at distances determined based on the corresponding travel time, and (iv) in response to one of the indicators being selected, display geographic information related to the corresponding geographic area.

Another embodiment of these techniques is a method for providing interactive geographic content via a user interface. The method includes receiving a description of several geographic areas of different sizes, each organized around a respective commonality. For each of the geographic areas, the method includes determining a metric indicative of one of (i) a distance between a reference location and the geographic area or (ii) travel time between the reference location and the geographic area. The method further includes displaying individually selectable indicators, each representing a respective one of the geographic areas, within multiple demarcated concentric ring sectors centered around an indication of the reference location, each of the ring sectors having an inner radius and an outer radius corresponding to a lower boundary and a higher boundary, respectively. Displaying the selectable indicators also includes selecting, for each of the indicators, one of the concentric ring sectors so that the metric of the corresponding geographic area is between the lower boundary and the higher boundary of the ring sector.

### BRIEF DESCRIPTION OF THE DRAWINGS

FIG. 1 illustrates an example computing system in which a client device can generate a schematic representation of geographic locations according to the techniques of this disclosure;

FIGS. 2A-5B illustrate example screenshots which the client device of FIG. 1 can generate during user interaction with selectable indicators of geographic locations;

FIG. 6 is a flow diagram of an example method for generating a display of selectable location indicators, which can be implemented the client device of FIG. 1; and

FIG. 7 is a flow diagram of an example method for executing tasks related to providing geographic content based on a selection of a geographic area, which also can be implemented the client device of FIG. 1.

### DETAILED DESCRIPTION

### General Overview

The techniques of the present disclosure allow a client device to efficiently arrange selectable indicators of geographic locations on a user interface. According to one implementation, a certain reference location, such as a location related to a geographic search or the current geographic location of the client device, is schematically indicated at an edge (e.g., one of the corners) of a user interface (e.g., a touchscreen) of the client device. The remaining portion of the user interface is divided into concentric ring sectors centered at the indicator of the reference location. Each sector may represent a certain number of minutes of travel from the reference location or a certain distance from the current location, and each sector includes one or more selectable indicators of the geographic areas.

For example, a user's current location may be within a large city. A first sector (immediately surrounding the indication of the reference location) may include selectable indicators of neighborhoods that are approximately five minutes away by public transport, and a next sector (surrounding the first sector) can include a list of neighborhoods that are approximately ten minutes away, etc.

Each indicator can include the name of the corresponding geographic area. In a typical scenario, the client device displays the established names of neighborhoods, which can come from e.g., government) listing, real estate listings, or informal but well-known names people give to neighborhoods. In some cases, however, names of geographic locations, or neighborhoods, are generated automatically based on the presence of certain types of businesses (e.g., “the restaurant district”), landmarks (e.g., (“the Rodin sculpture area”), transportation hubs (e.g., “the airport area”), etc. in the geographic areas.

The selectable indicators may not necessarily reflect the geography of the actual geography of the geographic areas, and the placement of selectable indicators within each ring may not necessarily reflect the actual locations of the geographic areas relative to each other. Thus, a pair of neighborhoods of different sizes that are not adjacent, but are both ten minutes away from the reference location, may be represented in this schematic representation by adjacent selectable indicators of the same size. In some implementations, the relative placement of selectable indicators within a certain ring sector can correspond to the richness and/or ranking of geographic content available for the geographic area.

The user can tap or click on a selectable indicator to activate the display of geographic content for the area. This content can include listings of businesses and points of interest, as well as advertisements, offers, coupons, automatic recommendations, etc.

A metric indicating how far a geographic area is removed from the reference location can correspond to travel time by public transportation, by car, on foot, etc. between the reference location and some point in the geographic area. This point can be the landmark around which the geographic area is organized, a major intersection in the geographic area, a public transport station, a centroid of the polygon enclosing the geographic area, etc.

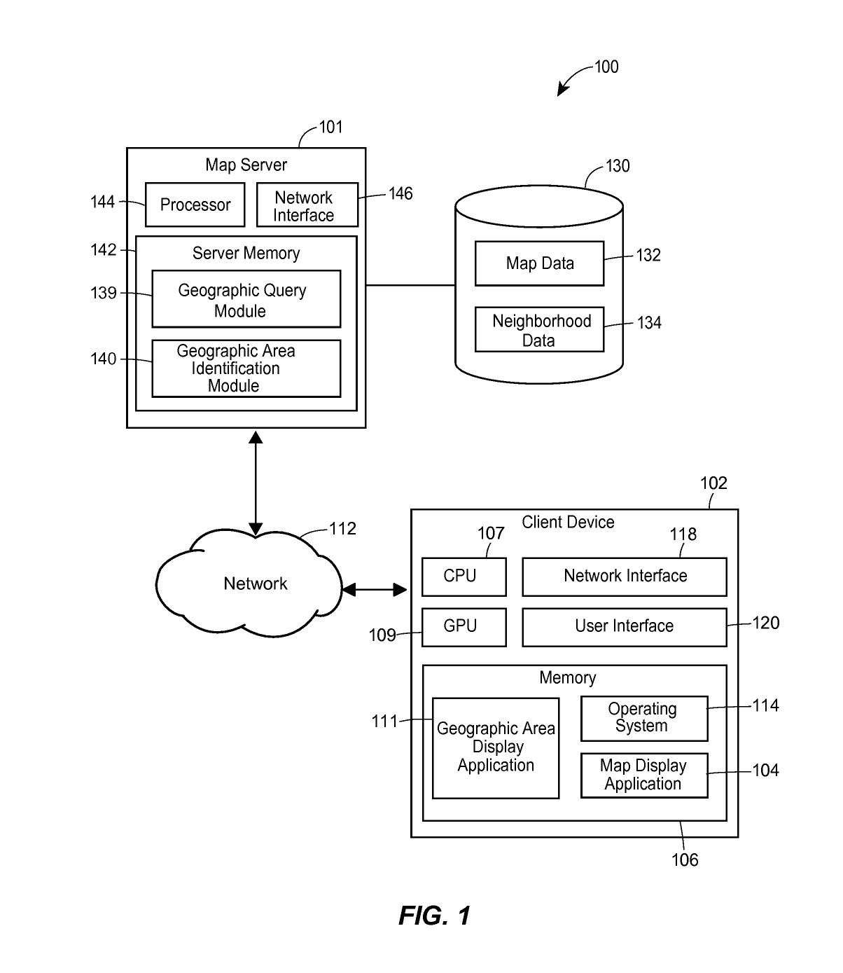

These techniques are now discussed in more detail with reference to FIGS. 1-7.

### System Overview

FIG. 1 illustrates an example computing environment 100 in which location information may be conveyed to a user of a client device 102. The client device 102 may display maps or other geographically related information via a map display application 104, which is stored in memory 106 as a set of instructions and executes on a CPU 107 and/or a graphic processing unit (GPU) 109. The map display application 104 in general can display digital map content supplied by a map server 101 via a network 112, which can be a wired or wireless network (e.g., the Internet). For example, the map display application 104 may be a special-purpose application available at an online application store disposed at the map server 101 or an application server (not shown). A user of the client device 102 may retrieve a copy of the map display application 104 from the application server and install the retrieved copy of the mapping application on the client device 102. In other implementations, the map display application 104 can be a software component, such as a plug-in, that operates in a web browser (e.g., Google Chrome® or Apple's Safari®) or another application.

The client device 102 may also execute a geographic area display application 111 to determine, arrange, and schematically display geographic locations or areas to a user of the client device 102. The client device 102 may determine, for example, neighborhoods at various distance increments or travel time increments from a current location, where the current location may be a location displayed by the map display application 104 or a current physical location of the client device 102. The client device 102 may organize or arrange these neighborhoods according to the distance or travel time increments from the current location and schematically display the neighborhoods on a user interface 120 of the client device 102. It is clear that geographic locations (e.g., determined, arranged, and displayed by the geographic area display application 111) may correspond to any formally or informally named geographic areas, such as neighborhoods of a large city, suburbs, towns, villages, parks, city districts, recreational areas, areas surrounding a natural or manmade landmark, government or corporation campuses, etc. The current location itself may include a formally or informally defined geographic area (e.g., “The Loop” area of Chicago, or “the restaurant district” of a major city), or the current location may be represented by a geographic point, such as an address, latitude and longitude, etc.

The memory 106 may be tangible, non-transitory memory and may include any types of suitable memory modules, including random access memory (RAM), read-only memory (ROM), a hard disk drive, flash memory, or other types of memory. In addition to the map display application 104 and the geographic area display application 111, the memory 106 may store an operating system (OS) 114 and one or more local applications or modules (not shown). The operating system 114 may be any type of suitable operating system, and the one or more local applications may include a variety of installed applications. The map display application 104 can receive digital content via a network interface 118, and a user can interact with the map display application 104 via the user interface 120, which can include a touchscreen, a screen along with a keyboard and a mouse, speakers, etc.

In general, the client device 102 can be any suitable portable or non-portable computing device. By way of example, the client device 102 may be a smartphone, a tablet computer, a laptop computer, etc. In various implementations, the client device 102 can include fewer components than illustrated in FIG. 1 or, conversely, additional components. In some implementations, for example, the client device 102 includes multiple instances of the CPU 107.

The map server 101 may be communicatively coupled to multiple databases, such as a database 130. The database may store map data 132 including street and road information, topographic data, satellite imagery, information related to public transport routes, information about businesses or other points of interest (POIs), information about current traffic conditions, etc. The database 130 may also store neighborhood data 134 including indications of formally defined (e.g., by government regulation) or informally defined (e.g., by common names or landmarks) geographic areas. For example, the neighborhood data 134 may include geographic representations (e.g., polylines representing borders of) of neighborhoods and/or names of neighborhoods (e.g., “Lincoln Park” in Chicago, or “Upper East Side” in New York), shopping or restaurant districts of large cities, suburb areas, etc.

Although shown as being stored in a single database 130 in FIG. 1, it is understood that the map data 132 and neighborhood data 134 may be stored on any number of databases in any number of physical locations. For example, vector and raster graphics in the map data 132 may be stored in two separate databases, respectively communicatively coupled to the map server 101, and at least some of the neighborhood data 134 may be stored in government databases, or other public accessible databases, communicatively coupled to the map server 101.

It will be understood that although the map server 101 is illustrated in FIG. 1 as a single device, in general the map server 101 can correspond to multiple servers responsible for respective types of content or respective map-related task executions. In the illustrated implementation, the map server 101 includes a geographic query module 139 and a geographic area identification module 140 stored in a server memory 142 and executed by a server CPU 144.

By executing the geographic query module 139 (e.g., via one or more processors 144), the map server 101 may, in some cases, satisfy geographic queries initiated at the client device 102. For example, a user of the client device 102 may search for a types of businesses (pizza restaurant, bicycle shop, etc.) via user interaction with the map display application 104. Subsequently, the client device 102 may send a request for related map data to the map server 101, and the map server 101 may execute the geographic query module 139 to provide relevant (e.g., geographically and semantically proximate) portions of the map data 132 to the client device 102 (e.g., via a network interface 146).

Further, the map server 101 may automatically re-execute previously requested geographic queries upon user interactions with the geographic area display application 111. For example, upon a user selection of a geographic area in a schematic representation of geographic areas displayed on the client device 102, the map server 101 may automatically re-execute a previously requested geographic query for the selected geographic area. Such automatic re-execution is further discussed with reference to FIG. 7.

In some cases, the map server 101 may execute the geographic area identification module 140 to determine relevant geographic locations for a client device 102. For example, along with communicating portions of the map data 132 to the client device 102 (e.g., indications of bicycles shops in “The Loop” area of Chicago), the map server 101 may execute the geographic area identification module 140 to provide indications of one or more geographic locations corresponding to communicated portions of the map data 132 (e.g., neighborhoods of Chicago close to “The Loop” area). The geographic area identification module 140 may, in some implementations, automatically generate names of geographic locations or areas based on portions of the map data 132 (e.g., indications of types of businesses, names of businesses, or landmarks), or the geographic area identification module 140 may retrieve geographic location names from the neighborhood data 134.

### Schematic Representations of Geographic Locations

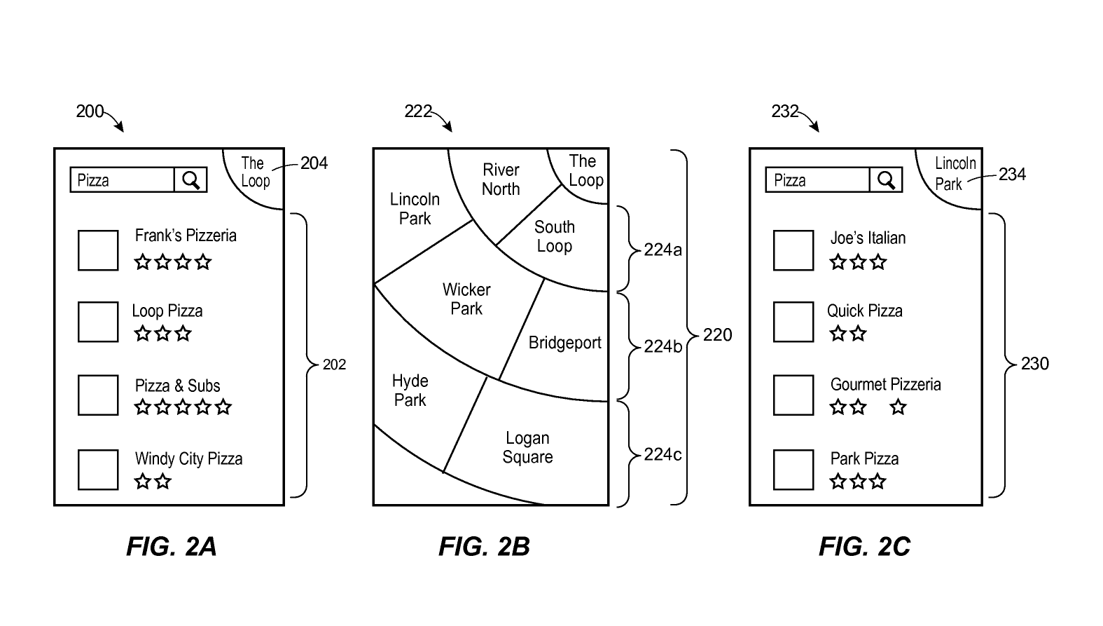

FIGS. 2A, 2B, and 2C are screenshots that illustrate an example scenario in which a current geographic location/area is indicated on a client device (e.g., within a list view of a mapping application), a schematic representation of geographic locations (or areas) is displayed on the client device, and a user selects one of the geographic locations to view geographically information related to the selected geographic location. The client device 102 may execute the map display application 104 and/or geographic area display application 111 to display the screenshots of FIGS. 2A, 2B, and 2C on the user interface 120, for example.

FIG. 2A is an example screenshot 200 of a list view (e.g., non-map view) of a mapping application. The list view may include a listing 202 of one or more map items or information related to points of interest (POIs), in the scenario. For example, the map display application 104, when executed by the CPU 107 and/or GPU 109, may cause the listing 202 to be displayed on the user interface 120. The map display application 104 may generate the display of the listing 202 in response to receiving map data (e.g., from the map server 101) resulting from a geographic query.

For example, a user of the client device 102 may input a geographic query “Pizza Loop Chicago” into the user interface 120. Subsequently, the client device 102 may send a request for related map data to the map server 101, and the map server may query the map data 132 for portions of the map data 132 corresponding to pizza restaurants in “The Loop” area of Chicago. The map server 101 may send relevant portions of the map data 132 to the client device 102, where the map display application 104 generates the listing 202 of pizza restaurants in “The Loop” area of Chicago.

The listing 202 may include, by way of example, business names, business logos or pictures, and business ratings, in the scenario. However, in general, it is understood that any number and type of geographically related information may be displayed in a list view of a map display application, such as addresses, textual descriptions, advertisements, coupons, etc.

Along with the listing 202, the client device 102 may display an indication 204 of a current or reference location. The current or reference location may correspond to an area indicated in a geographic query (e.g., “The Loop” area of Chicago as indicated in the query “Pizza Loop Chicago”), in the example scenario. However, it is understood that a reference location may correspond to other selected, detected, or inferred locations, such as a current physical location of a client device or a previously displayed viewport of a mapping application, assuming a user consents to such user of a current physical location or viewport history. For example, a user may input a simple query “Pizza” into the client device 102 while the client device 102 is physically located in “The Loop” area of Chicago or while a viewport of a digital map is displaying “The Loop” area of Chicago. Subsequently the map display application 104 and/or geographic area display application 111 may cause a listing and indication similar to that of the listing 202 and indication 204, respectively, to be displayed on the client device 102.

In the example scenario, the indication 204 may include a neighborhood name, “The Loop.” The map server 101 may send such a neighborhood name to the client device 102 along with map data or information corresponding to the POIs in the listing 202. Alternatively, the client device 102 or map server 101 may automatically infer the neighborhood name based on the map data corresponding to the POIs in the listing 202. For example, one or more of the POIs in the listing 202 may correspond to portions of map data (descriptions, addresses, reviews, web pages, labels, database entries, etc.) in the map data 132 that include indications of “The Loop” area of Chicago. As such, an algorithm executed as part of the geographic area identification module 140 or geographic area display application 111 may automatically analyze the portions of map data to infer a name including “The Loop.”

The client device 102 may display the example indication 204 of the current, or reference, geographic area in a corner of the screenshot 200. In such a manner, the indication 204 of the current geographic area may allow a current geographic location to be conveyed to a user, while avoiding any cluttering or unnecessary distractions on the user interface 120 (e.g.., screen) of the client device 102. The indication 204 allows a user to easily understand a current geographic location associated with the listing 202.

Further, indications of current geographic locations, such as the indication 204, may be interactive, in an implementation. A user of the client device 102 may select the indication 204 with a click or tap, or, in some cases, a user of the client device 102 may select the indication 204 with a slide, fling, or other suitable gesture on a touchscreen. When selected, the geographic area display application 111 may cause a schematic representation 220 of geographic locations or areas to be displayed, as illustrated in the screenshot 222 of FIG. 2B.

The schematic representation 220 may be divided into one or more sectors 224a, 224b, and 224c surrounding (e.g., in concentric circles or rings) the indication 202 of the current geographic area. Each of the sectors 224a, 224b, and 224c may correspond to an approximate travel time increment (five minutes, ten minutes, thirty minutes, one hour, etc.) or an approximate distance increment (5 miles, ten miles, fifteen miles, etc.) from the current geographic location. For example, the sector 224a may include indications of geographic areas which are approximately five minutes travel time form the current geographic location, the sector 224b may include indications of geographic areas which are approximately ten minutes travel time from the current geographic location, and the sector 224c may include indications of geographic areas which are approximately twenty minutes travel time from the current geographic location. As with the indication 204, the indications of geographic areas in the sectors 224a, 224b, and 224c may include an informal or common name of one or more geographic areas (e.g., neighborhoods of a large city). It is understood, however, that the indications of geographic areas may include formal or informal names of suburbs, town, districts, or any other geographic areas.

The schematic representation 220 of the screenshot 222 may allow a user to quickly view location information from within the list view of screenshot 200. In the scenario, the indication 204 may allow a user to understand that the listing 202 is associated with “The Loop” area of Chicago, and, by selecting the indication 204, the user may quickly view other Chicago neighborhoods that are close to “The Loop.” The schematic representation 220 allows the user to simultaneously view indications of neighborhoods that are proximate to “The Loop,” such as “River North” and “South Loop,” and further away from “The Loop,” such as “Wicker Park” or “Hyde Park,” arranged in a logical representation based on travel time or distance from “The Loop.”

One or more of the sectors 224a, 224b, and 224c of the schematic representation 220 may, in some cases, include indications which are adjacent in a respective one of the sectors 224a, 224b, and 224c but are not geographically adjacent. In the scenario, for example, the sector 224c includes indications of the “Hyde Park” and “Logan Square” neighborhoods of Chicago. However, “Hyde Park” and “Logan Square” are not geographically adjacent neighborhoods. Rather, the geographic area display application 111 may include “Hyde Park” and “Logan Square” in the same sector 224c because they are both approximately a fifteen minute drive from “The Loop” (i.e., they corresponding to the same travel time increment form the current location).

As with the indication 204, the indications of geographic areas or locations in the sectors 224a, 224b, and 224c may each be selectable, or each of the sectors 224a, 224b, and 224c may be selectable as a whole. For example, a user may select (e.g., with a click or tap) one of the indications of geographic locations in the sectors 224a, 224b, and 224c to replace the current geographic location (e.g., “The Loop”) with a new geographic location (e.g., “Lincoln Park”). That is, the user may no longer be interested in the listing 202 associated with “The Loop,” and, by selecting the “Lincoln Park” indication in the sector 224b, the user may change the current geographic location to “Lincoln Park” so as to see a new listing 230 associated with the “Lincoln Park” area of Chicago, as illustrated in the screenshot 232 of FIG. 2C.

In an implementation, the map server 101 and the client device 102 may re-execute a geographic query, and/or other map-related tasks previously executed, to produce the listing 202 based on a selected one of the indications of geographic areas. In the example scenario, upon selection of the “Lincoln Park” indication in sector 224b, the map server 101 and/or client device 102 may re-execute a query of the map data 132 for pizza restaurants. However, the re-execution of the query may be for pizza restaurants in the “Lincoln Park” area of Chicago, rather than in “The Loop” area of Chicago. The map display application 104 may display resulting portions of the re-execution as the listing 230 along with a new interactive indication 234 of the selected geographic area.

Although the schematic representation 220 includes a plurality of sectors in the shape of concentric circles or rings around the indication 204 at a corner of a screen, sectors, or any other organizational divisions, of a schematic representation may be displayed as any shape. For example, sectors or divisions of a schematic representation may be displayed as portions of an oval, rectangle, column, polygon, etc. Further, an indication of a current geographic location or selected geographic area may be displayed at any suitable position on a screen (e.g., displaying a list view of a mapping application), such as along one of the edges, at the top, at the bottom, etc. Generally, rings of a schematic representation may include all or part of any shape defined by a closed curve, such as a circle, oval, hexagon, irregular curve, etc. In some cases, a closed curve defining of one ring of a schematic representation may, at all points, lie within a closed curve defining an adjacent ring of the schematic representation, and vice versa.

Still further, although the schematic representation 220 emphasizes concentric circles or rings around the indication 204 at a corner of a screen, it is clear that sectors or divisions of a schematic representation may not be truly concentric about an indication of a current location. For example, sectors or divisions of a schematic representation may include any suitable adjacent bands at varying distances from an indication of a current location, where the boundaries or shapes of the bands are only approximately concentric with an indication of a current location or are otherwise centered for aesthetic and/or practical reasons.

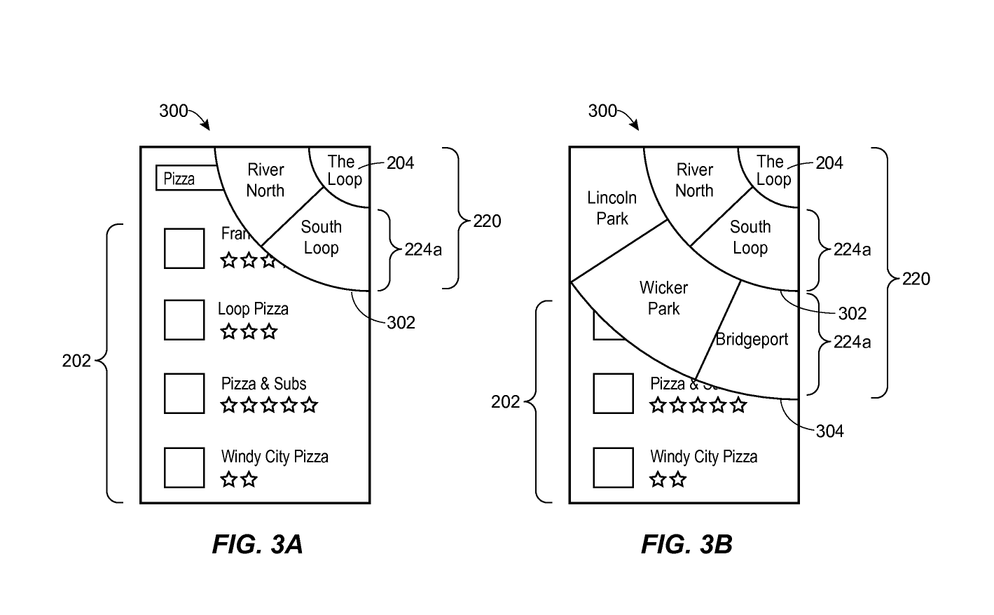

In some implementations, schematic representations may be displayed more or less completely based on a user selection of an indication of current location. For example, a user may select the indication 204 with a swipe or fling gesture, and, depending on the extent of the swipe or an acceleration of the fling, the geographic area display application 111 may display more or less of the schematic representation 220. As illustrated in the example screenshot 300 of FIG. 3A, the client device 102 may only display the sector 224a of the schematic representation 220 when a user performs a “drag” motion (or swipe gesture) from the indication 204 to an approximate outer edge 302 of the sector 224a. On the other hand, the client device 102 may display both of the sectors 224a and 224b when a user inputs a drag gesture from the indication 204 to an approximate outer edge 304 of the sector 224b, as illustrated in the example screenshot 310 of FIG. 3B. In this manner, schematic representations may allow a user to selectively view more or less indications of geographic areas and/or view only indications of certain geographic areas corresponding to particular travel times or distance increments.

Schematic representations may also overlap or overlay a list view, or other view, generated by a map display application. As illustrated in FIGS. 3A and 3B, portions of the schematic representation 220 may overlap the listing 202, where the listing 202 was displayed prior to expanding the schematic representation 220 from the indication 204. In some implementations, the geographic area display application 111 and/or the map display application 104 may display the schematic representation 220 with greater emphasis than it displays list views, or other map views, under the schematic representation 220 (i.e., on which the schematic representation 220 is overlapped). For example, the screenshots 300 and 310 may include a “grayed out” (i.e., displayed with only light gray colors), blurred, or otherwise de-emphasized version of the listing 202, while the schematic representation 220 is bold, sharply defined, colored, or otherwise emphasized.

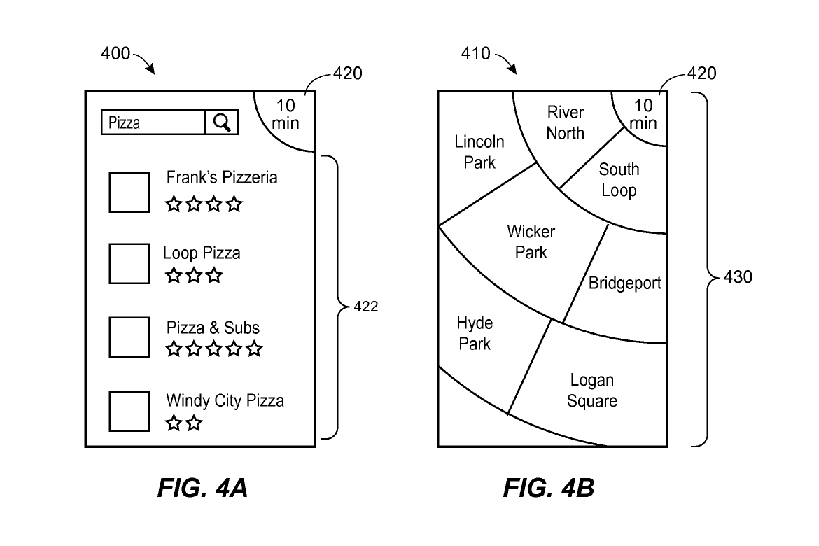

Further, indications of current geographic locations and/or schematic representations may include indications of travel times, travel distances, etc. in addition to or along with names of current or identified (e.g., by the geographic area identification module 140) geographic areas. As illustrated in the example screenshots 400 and 410 of FIGS. 4A and 4B, respectively, an indication 420 of a current geographic location may include a current travel time. That is, the indication 420 may indicate a current approximate travel time (e.g., ten minutes) corresponding to one or more POIs in a listing 422, or other current view generate by a map display application. When selected, the indication 420 may expand to a schematic representation 430 similar to that of the schematic representation 220 with a plurality of indications of geographic areas arranged in sectors. Each of the sectors of the schematic representation 220 may correspond to a travel time increment different and greater than the travel time indicated by the indication 420.

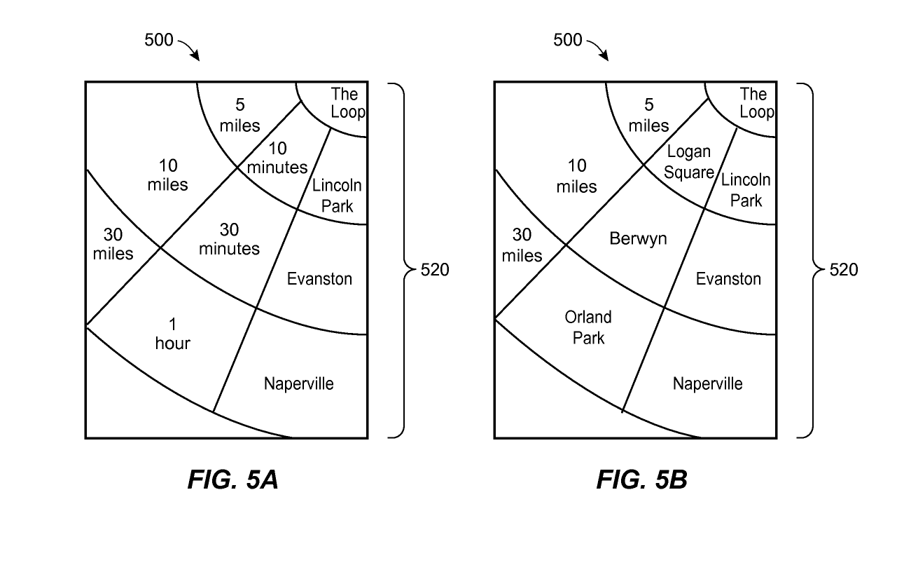

Generally, any of the sectors or divisions of a schematic representation may include, or may be labeled with, indications of travel times, indications of distances, and/or names of geographic areas. FIGS. 5A and 5B include example screenshots 500 and 510, respectively, in which a schematic representation 520 and a schematic representation 530 include at least one indication of travel time or distance. The indications of travel time and/or distance within a sector of the schematic representations 520 and 530 may represent a travel time increment or a distance increment corresponding to that sector and approximately corresponding to travel times to and distances from geographic areas indicated in that sector, for example.

### Generating and Displaying Schematic Representations

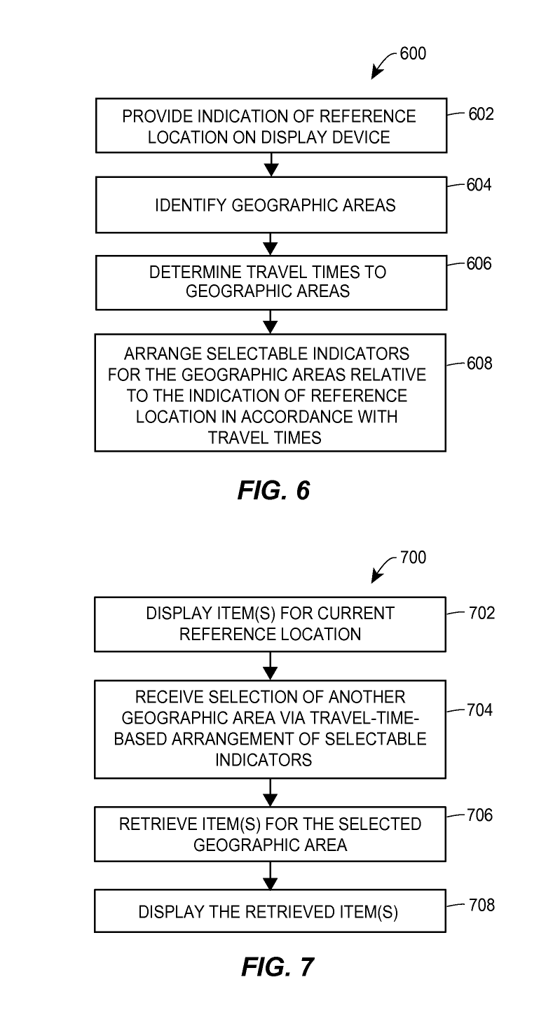

FIG. 6 is a flow diagram of an example method 600 for providing interactive geographic content via a user interface of a client device via schematic representations. The method 600 may be implemented in the client device 102, for example.

At block 602, an indication of a reference, or current, geographic location is displayed on a client device. The client device 102, for example, may display (e.g., via execution of the map display application 104 and/or the geographic area display application 1111) an indication of a current geographic location along with a list view, or other non-map view, of map data. The indication may include a name of the current geographic area or location, such as in the indication 204, or the indication may include a travel time or distance indicative of the current geographic location, such as in the indication 420.

A user may select the indication of the current geographic location. For example, a user of the client device 102 may click or tap on the indication of the current geographic area (e.g., on a touchscreen user interface), and, in some cases, the user may input a gesture (e.g., a drag or swipe gesture) originating at or intersecting with the indication.

At block 604, a plurality of geographic areas is identified. To determine or identify the geographic areas, the client device 102 may request an indication of one or more geographic areas from the map server 101, in an implementation. Upon receiving the request, the map server 101 may generate indications of geographic areas (e.g., names of neighborhoods) by querying the neighborhood data 134 or by analyzing portions of the map data 132. Subsequently, the map server 101 may send the indications of identified geographic areas to the client device 102.

In other implementations, a map server, such as the map server 101, may automatically identify geographic areas. For example, when the client device 102 forwards a request for a geographic query “Pizza Loop Chicago” to the map server 101, the map server may respond to the request with: (i) map data or items (advertisements, coupons, etc.) related to pizza restaurants in “The Loop” area of Chicago; and (ii) indications of identified geographic areas within a certain distance or travel time of “The Loop” area of Chicago. Subsequently, when an indication, such as the indication 204, is selected, a client device may identify geographic areas based on data already received from the map server 101 (i.e., cached data).

In still other implementations, the client device 102 may locally identify (e.g., with the CPU 107) geographic areas based on an analysis of map data. For example, the client device 102 may execute the geographic area display application 111 to analyze map data (e.g., received from the map server 101) so as to identify formal (city, town, village, etc.) or informal (neighborhoods, districts, etc.) names of geographic areas. Such an analysis may include an analysis of textual POI descriptions, web pages, ratings, titles, addresses, etc. to identify common terms, phrases, etc. indicative of geographic areas.

At block 606, travel times to the identified geographic areas are determined. The geographic areas (e.g., a list of neighborhoods and indications of corresponding approximate locations) may be divided or grouped into one or more sectors or divisions. For example, the geographic area display application 111 may group neighborhoods into a first sector of neighborhoods approximately ten minutes travel time from a current neighborhood (i.e., geographic area), a second sector of neighborhoods approximately fifteen minutes travel time from the current neighborhood, etc.

Generally, a geographic area display application, or other suitable application, may group or divide geographic areas based on any suitable type of distance based or travel-time based calculation. In a simplistic implementation, the geographic area display application 111 may calculate direct distances between an approximate center of a plurality of neighborhoods and a center of a current neighborhood and estimate travel time based on an average or likely speed of travel (e.g., when walking, driving, or riding public transportation). Alternatively, geographic area display application 111 may execute a more sophisticated algorithm taking into account, by way of example, time of day, current traffic conditions, current weather conditions, etc., to determine travel times between a current neighborhood and a plurality of neighborhoods. In some cases, the geographic area display application 111 may utilize techniques, similar to those used to generate directions for navigation, as known in the industry, to determine travel times, direct distances, or distances/travel times along a certain travel route.

At block 608, selectable indicators for the plurality of geographic areas are arranged relative to the indication of the reference location. The client device 102 may arrange and display the selectable indicators of geographic areas in a schematic representation similar to the schematic representations 220, 430, 520, or 530. In an implementation, the arrangement of the selectable indicators is based on travel times to the geographic areas, which were determined at 606. The schematic representation may include selectable indicators or indications of only some of the identified geographic areas. Further some sectors of a schematic representation may include different numbers of indicators of geographic areas as compared with other sectors of a schematic representation.

FIG. 7 is an example method 700 for automatically retrieving and displaying map items for a selected geographic area (e.g., within a schematic representation, such as the schematic representation 220). The example method 700 may be implemented by the client device 102, for example.

At block 702, map items are displayed for a current or reference geographic location. The map display application 104 may, by way of example, display POIs, geographic query results, driving directions, advertisements, coupons, business information, etc. associated with a reference geographic location. In some cases, the map display application 104 may display the map items in a non-map view. That is, the map items may be displayed in a list view (such as the list view in the screenshot 200), or other view representing the items as lists, tables, textual descriptions, etc.

The map display application 104 may display the map items along with an indication of the reference location. For example, the geographic area display application 111 may overlay an indication of the reference location on top of the display of the map items.

At block 704, a selection of another geographic area or location is received via a travel-time based arrangement of selectable indicators. A user may select an indication of the reference geographic location to view a schematic representation of selectable indicators of other geographic areas arranged based on travel time, as further discussed with reference to FIG. 6. The user may then select one of the indications of geographic areas (e.g., a nearby neighborhood) in the schematic representation.

At block 706, map items are retrieved for the selected geographic area. For example, the client device may request that the map server 101 re-execute a previously requested geographic query for the selected geographic area. A geographic query for bicycle shops, originally executed for bicycle shops in the reference geographic area, may be re-executed for bicycle shops in the selected geographic area.

Although previously initiated map tasks, such as geographic queries, may be automatically re-executed based on the selection of a geographic area, it is understood that new and different map tasks may also be initiated in response to a selection of a geographic area. In one scenario, a selection of a “Lincoln Park” neighborhood may initiate the generation or rendering of a digital map of the “Lincoln Park” area of Chicago, even if a digital map was not previously being display on the client device 102. In another scenario, the selection of a geographic area may trigger the display of one or more forms, buttons, messages, etc. prompting the user of the client device 102 for instructions on what type of map task is to be performed according to the selected geographic area.

At block 708, the retrieved items are displayed on the client device. The map display application 104 may display map items resulting from a re-execution of a map task for a newly selected geographic area (such as in the listing 230), or the map display application may display map items resulting from a new or different map task specifically corresponding to the selected geographic area.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for conveying location information to users of client devices through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A method for providing interactive geographic content via a user interface, the method comprising:
receiving, by one or more processors, a description of a plurality of geographic areas of different sizes; 21
for each of the plurality of geographic areas, determining, by the one or more processors, a respective travel time between the geographic area and a current location of a user;
displaying a plurality of individually selectable indicators, each representing a respective one of the plurality of geographic areas, including arranging the indicators relative to a point corresponding to the current location, at distances determined based on the corresponding travel times; and
in response to an indication that one of the indicators has been selected, displaying geographic information related to the corresponding geographic area.

2. The method of claim 1, wherein arranging the indicators relative to the point includes:
organizing, by the one or more processors, the plurality of indicators into several groups based on the travel times, and
displaying the plurality of indicators in positions within a set of two or more concentric rings, wherein each of the groups corresponds to a different ring.

3. The method of claim 2, further comprising:
associating a corner of a screen with the point corresponding to the current location, and
centering, by one or more processors, the set of concentric rings at the corner of the screen.

4. The method of claim 2, further comprising:
for each group of indicators:
ranking the corresponding geographic areas based on the available geographic information;
arranging the selectable indicators along an inner circumference of the corresponding ring in an order based on the ranking.

5. The method of claim 2, further comprising:
illustrating boundaries between adjacent rings, and
displaying a respective indicator of travel time for each of the rings.

6. The method of claim 1, wherein determining the travel time between a geographic area and the current location of a user includes:
receiving, by the one or more processors, an indication of a geographic location within the geographic area, and
determining the travel time between the geographic location and the current location;
wherein the indicated geographic location corresponds to one of (i) a landmark, (ii) a transportation hub, or (iii) a centroid of the geographic area.

7. The method of claim 1, wherein displaying geographic information related to the corresponding geographic area includes displaying a list of selectable items, each describing one of (i) an automatic suggestion, (ii) an offer, (iii) a coupon, or (iv) an advertisement.

8. The method of claim 7, further comprising:
displaying, along with the geographic information related to the geographic area, a selectable current location indicator that represents the current location; and
in response to the current location indicator being selected, re-activating the display of the plurality of individually selectable indicators representing the plurality of geographic areas.

9. The method of claim 1, wherein each of the plurality of geographic areas is organized around one of (i) a neighborhood name, (ii) a popular landmark, (iii) a personal landmark specific to the user.

10. A user device comprising:
a display device;
a communication interface; and
processing hardware coupled to the display device and the communication interface, the processing hardware configured to:
receive a description of a plurality of geographic areas of different sizes,
for each of the plurality of geographic areas, determine a respective travel time between the geographic area and a reference location,
display a plurality of individually selectable indicators on the display device, each representing a respective one of the plurality of geographic areas, arranged relative to a point on the display device corresponding to the reference location, at distances determined based on the corresponding travel times, and
in response to one of the plurality of indicators being selected, display geographic information related to the corresponding geographic area.

11. The user device of claim 10, wherein to arrange the plurality of indicators relative to the point, the processing hardware is configured to:
organize the plurality of indicators into several groups based on the travel times, and
display the plurality of indicators in positions within a set of two or more concentric rings, wherein each of the groups corresponds to a different ring.

12. The user device of claim 11, wherein the processing hardware is further configured to:
illustrate boundaries between adjacent rings, and
display a respective indicator of travel time for each of the rings.

13. The user device of claim 10, wherein user device is a mobile device, and wherein the reference location is a current location of the mobile device.

14. The user device of claim 13, wherein to determine the travel time between a geographic area and the current location of the mobile device includes:
select a geographic location within the geographic area, and
determine the travel time between the geographic location and the current location;
wherein the indicated geographic location corresponds to one of (i) a landmark, (ii) a transportation hub, or (iii) a centroid of the geographic area

15. The user device of claim 10, wherein to display geographic information related to the corresponding geographic area, the processing hardware is configured to display a list of selectable items, each describing one of (i) an automatic suggestion, (ii) an offer, (iii) a coupon, or (iv) an advertisement.

16. A method for providing interactive geographic content via a user interface, the method comprising:
receiving, by one or more processors, a description of a plurality of geographic areas of different sizes, each organized around a respective commonality;
for each of the plurality of geographic areas, determining, by the one or more processors, a metric indicative of one of (i) a distance between a reference location and the geographic area or (ii) travel time between the reference location and the geographic area; and
displaying a plurality of individually selectable indicators, each representing a respective one of the plurality of geographic areas, within multiple demarcated concentric ring sectors centered around an indication of the reference location, each of the ring sectors having an inner radius and an outer radius corresponding to a lower boundary and a higher boundary, respectively; including selecting, for each of the plurality of indicators, one of the concentric ring sectors so that the metric of the corresponding geographic area is between the lower boundary and the higher boundary of the ring sector.

17. The method of claim 16, further comprising, in response to one of the indicators being selected:
removing the display of the plurality of indicators, and
displaying geographic information related to the corresponding geographic area.

18. The method of claim 17, wherein displaying geographic information related to the corresponding geographic area includes displaying a list of selectable items, each describing one of (i) an automatic suggestion, (ii) an offer, (iii) a coupon, or (iv) an advertisement.

19. The method of claim 16, displaying a respective indicator of travel time for each of the ring sectors.

20. The method of claim 16, wherein the commonality includes one of (i) a neighborhood, (ii) a popular landmark, (iii) a personal landmark specific to the user.
